(19) United States
(12) Patent Application Publication
(10) Pub. No.: US 2023/0254214 A1
(43) Pub. Date: Aug. 10, 2023

(54) CONTROL APPARATUS, VIRTUAL NETWORK ASSIGNMENT METHOD AND PROGRAM

(71) Applicant: NIPPON TELEGRAPH AND TELEPHONE CORPORATION, Tokyo (JP)

(72) Inventors: Akito SUZUKI, Tokyo (JP); Shigeaki HARADA, Tokyo (JP)

(21) Appl. No.: 18/003,237

(22) PCT Filed: Jul. 20, 2020
(86) PCT No.: PCT/JP2020/028108

§ 371 Date: Dec. 23, 2022

(51) Int. Cl. H04L 41/0895; H04L 41/16

(52) U.S. Cl. CPC H04L 41/0895; H04L 41/16

(57) ABSTRACT

A control apparatus for allocating, by use of reinforcement learning, a virtual network to a physical network having links and servers comprises: a pre-learning unit that learns a first action value function corresponding to an action performing a virtual network allocation so as to improve the use efficiency of a physical resource in the physical network and further learns a second action value function corresponding to an action performing a virtual network allocation so as to suppress violations of constraints in the physical network; and an allocation unit that uses the first action value function and the second action value function to allocate the virtual network to the physical network.

### TECHNICAL FIELD

The present invention relates to a technique for allocating a virtual network to a physical network.

### BACKGROUND ART

With the development of NFV (Network Function Virtualization), it has become possible to execute VNF (Virtual Network Function) on general-purpose physical resources. By sharing physical resources among a plurality of VNFs by the NFV, improvement in resource utilization efficiency can be expected.

Examples of physical resources include network resources such as link bandwidth and server resources such as CPU and HDD capacity. In order to provide a high-quality network service at a low cost, it is necessary to allocate an optimal VN (Virtual Network) to physical resources.

A VN allocation means allocation of VN constituted by a virtual link and a virtual node to a physical resource. The virtual link represents network resource demands such as a required bandwidth and required delay between VNFs, and connection relationships between VNFs and users. The virtual node represents server resource demands such as the number of required CPUs for executing the VNF and the amount of required memory. An optimum allocation refers to an allocation that maximizes the value of an objective function such as the resource utilization efficiency while satisfying the constraint conditions such as service requirements and resource capacities.

In recent years, traffic and server resource demand fluctuations have become more severe due to high-quality video distribution and OS updates, and the like. In a static VN allocation in which a demand amount is estimated with a maximum value within a certain period and allocation is not changed with time, utilization efficiency of resources is reduced, and a dynamic VN allocation method following demand fluctuation of resources is required.

The dynamic VN allocation method is a method for obtaining the optimum VN allocation for the VN demand changing with time. The difficulty of the dynamic VN allocation method is that it is necessary to simultaneously satisfy the optimality and immediacy of allocation in a trade-off relationship. In order to increase the accuracy of the allocation result, it is necessary to increase the calculation time. However, the increase in the calculation time is directly connected to the increase in the allocation period, and as a result, the immediacy of the allocation is reduced. Similarly, in order to immediately cope with the demand fluctuation, it is necessary to reduce the allocation period. However, the reduction of the allocation period is directly connected to the reduction of the calculation time, and as a result, the optimization of the allocation is reduced. As described above, it is difficult to simultaneously satisfy the optimality and immediacy of allocation.

As a means for solving the difficulty of the dynamic VN allocation method, the dynamic VN allocation method by deep reinforcement learning has been proposed (see NPLs 1 and 2). Reinforcement learning (RL) is a method of learning a strategy in which the sum of rewards (cumulative rewards) that can be obtained over the future is the largest. The relationship between the network state and the optimum allocation is learned in advance by reinforcement learning, and optimization calculation at each time is made unnecessary, it is possible to realize the optimum and immediacy of the allocation at the same time.

### CITATION LIST

### Non Patent Literature

[NPL 1] Akito Suzuki, Yu Abiko, Shigeaki Harada, “A Study on Dynamic Virtual Network Allocation Method Using Deep Reinforcement Learning”, IEICE General Conference, B-7-48, 2019.

[NPL 2] Akito Suzuki, Shigeaki Harada, “Dynamic Virtual Resource Allocation Method Using Multi-agent Deep Reinforcement Learning”, IEICE Technical Report, vol. 119, no. 195, IN2019-29, pp. 35-40, September 2019.

### SUMMARY OF INVENTION

### Technical Problem

When reinforcement learning is applied to an actual problem such as VN allocation, there is a problem related to safety. It is important to maintain the constraint conditions in the control of the actual problem, but in general reinforcement learning, since the optimal strategy is learned only from the value of the reward, the constraint conditions are not always kept. Specifically, in general reward design, a positive reward corresponding to the value of the objective function when the constraint condition is satisfied, and a negative reward is given to an action not satisfying the constraint condition.

In general reinforcement learning, restriction conditions may not be met because it is allowed to receive a negative reward in the middle of the action in which the cumulative reward becomes maximum. On the other hand, in the control of the actual problem such as the VN allocation, it is required to always avoid violation of the constraint condition. In the example of the VN allocation, violation of the constraint condition corresponds to congestion of a network and overload of a server. In order to actually apply the dynamic VN allocation method by reinforcement learning, it is necessary to introduce a mechanism for avoiding a negative reward action for suppressing the restriction condition violation.

The present invention has been made in view of the above-mentioned points, and an object of the present invention is to provide a technique for dynamically allocating a virtual network to a physical resource by reinforcement learning in consideration of safety.

### Solution to Problem

According to the disclosed technique, a control apparatus is provided that allocates a virtual network to a physical network having a link and a server by reinforcement learning, a control apparatus comprising:

a pre-learning unit configured to learn a first action value function corresponding to an action of performing virtual network allocation so as to improve utilization efficiency of physical resources in the physical network and a second action value function corresponding to an action of performing virtual network allocation so as to suppress violation of constraint conditions in the physical network,

an allocation unit configured to allocate a virtual network to the physical network by using the first action value function and the second action value
function.

### Advantageous Effects of Invention

According to the disclosed technique, a technique is provided for dynamically allocating a virtual network to physical resources by reinforcement learning in consideration of safety.

### BRIEF DESCRIPTION OF DRAWINGS

FIG. 1 is a diagram illustrating a system configuration of an embodiment of the present invention.

FIG. 2 is a diagram illustrating a functional configuration of a control apparatus.

FIG. 3 is a diagram illustrating a hardware configuration of the control apparatus.

FIG. 4 is a diagram illustrating a definition of a variable.

FIG. 5 is a diagram illustrating a definition of a variable.

FIG. 6 is a flowchart illustrating the whole operation of the control apparatus.

FIG. 7 is a diagram illustrating a reward calculation procedure of go.

FIG. 8 is a diagram illustrating a reward calculation procedure of gc.

FIG. 9 is a diagram illustrating a pre-learning procedure.

FIG. 10 is a flowchart illustrating a pre-learning operation of the control apparatus.

FIG. 11 is a diagram illustrating an allocation procedure.

FIG. 12 is a flowchart illustrating an allocation operation of a control apparatus.

### DESCRIPTION OF EMBODIMENTS

Hereinafter, an embodiment of the present invention (the present embodiment) will be described with reference to the drawings. The embodiment described below is merely an example, and embodiments to which the present invention is applied are not limited to the following embodiment.

### Overview of Embodiment

In the present embodiment, the technique of a dynamic VN allocation by Safe Reinforcement Learning (safe-RL), which takes safety into consideration will be described. In the present embodiment, “safety” is the fact that the violation of the constraint condition can be suppressed, and “control considering safety” is the control having a mechanism for suppressing the violation of the constraint condition.

In the present embodiment, a mechanism for considering safety is introduced to a dynamic VN allocation technique based on reinforcement learning. Specifically, a function of suppressing violation of constraints is added to the dynamic VN allocation technology by deep reinforcement learning, which is an existing method (NPLs 1 and 2).

In the present embodiment, similar to the existing method NPLs 1 and 2, the VN demand at each time and the amount of use of the physical network are defined as states, changes in the route and the VN allocation are defined as actions, and reward design corresponding to an objective function and a constraint condition is performed, an optimal VN allocation method is learned. The agent learns the optimum VN allocation in advance, and the agent immediately determines the optimum VN allocation on the basis of the learning result at the time of actual control, thereby realizing the optimality and the immediacy at the same time.

### System Configuration

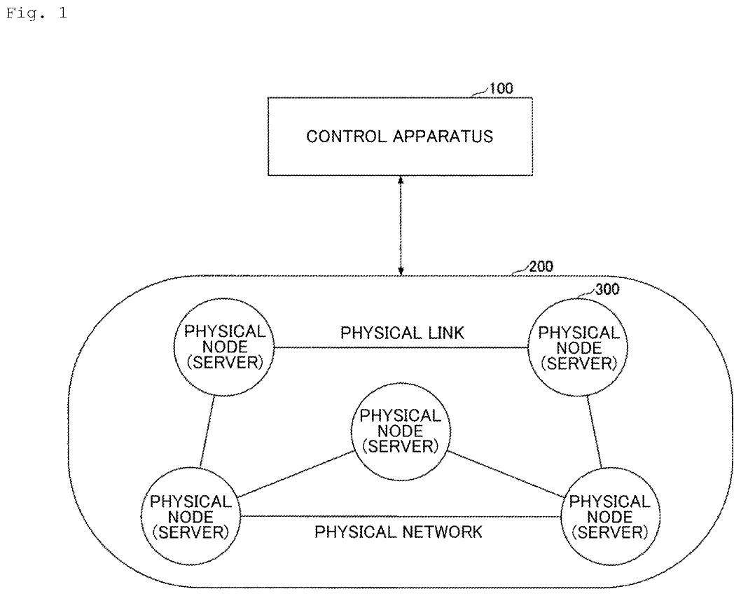

FIG. 1 shows an example configuration of a system of the present embodiment. As shown in FIG. 1, the system includes a control apparatus 100 and a physical network 200. The control apparatus 100 is an apparatus for executing the dynamic VN allocation by reinforcement learning in consideration of safety. The physical network 200 is a network having physical resources to be allocated by VN. The control apparatus 100 is connected to the physical network 200 by a control network or the like, and can acquire state information from a device constituting the physical network 200 or transmit a setting instruction to the device constituting the physical network 200.

The physical network 200 has a plurality of physical nodes 300 and a plurality of physical links 400 connecting the physical nodes 300. A physical server is connected to the physical node 300. Further, the physical node 300 is connected to a user (user terminal, a user network, or the like). In addition, it may be paraphrased that the physical server exists in the physical node 300 and the user exists in the physical node.

For example, when allocating a VN that communicates between a user existing in a certain physical node 300 and a VM to a physical resource, the physical server to which the VM is assigned, and the user (physical node) and the allocation destination A route (a set of physical links) to and from a physical server is determined, and settings are made to the physical network 200 based on the determined configuration. The physical server may be simply referred to as a “server” and the physical link may be simply referred to as a “link”.

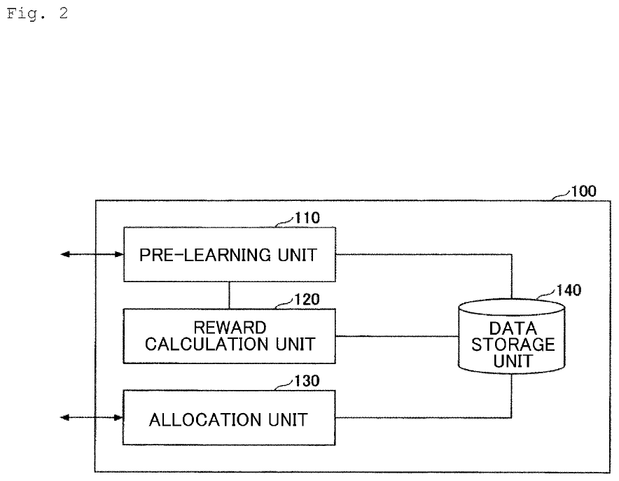

FIG. 2 illustrates an exemplary configuration of the control apparatus 100. As shown in FIG. 2, the control apparatus 100 includes a pre-learning unit 110, a reward calculation unit 120, an allocation unit 130, And a data storage unit 140. The reward calculation unit 120 may be included in the pre-learning unit 110. Further, “the pre-learning unit 110, the reward calculation unit 120”, and “the allocation unit 130” may be provided in separate devices (computers operating by the program, etc.). The outline of the functions of each unit is as follows.

A pre-learning unit 110 performs pre-learning of the action value function by using the reward calculated by the reward calculation unit 120. A reward calculation unit 120 calculates a reward. The allocation unit 130 executes allocation of VN to physical resources by using the action value function learned by the pre-learning unit 110. The data storage unit 140 has a function of Replay Memory and stores parameters and the like necessary for calculation. The pre-learning unit 110 includes an agent in a learning model of reinforcement learning. “Learning an agent” corresponds to the learning of the action value function by the pre-learning unit 110. The detailed operation of each unit will be described later.

### Example Hardware Configuration

The control apparatus 100 can be realized, for example, by causing a computer to execute a program. This computer may be a physical computer or a virtual machine.

In other words, the control apparatus 100 can be realized by executing a program corresponding to the processing executed by the control apparatus 100 with use of hardware resource such as a CPU and a memory built in a computer. The above program can be recorded on a computer-readable recording medium (a portable memory or the like), stored, and distributed. It is also possible to provide the program through a network such as the Internet or e-mail.

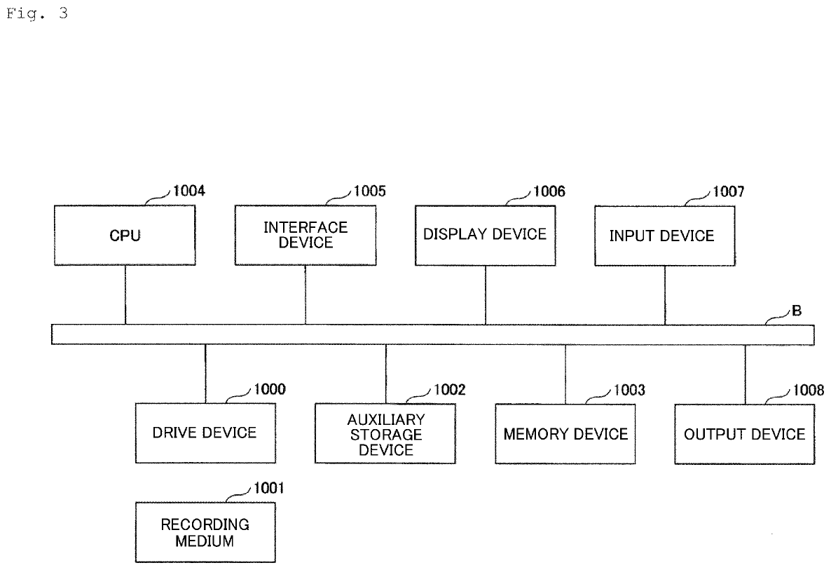

FIG. 3 is a diagram showing an example hardware configuration of the computer. The computer shown in FIG. 3 includes a drive device 1000, an auxiliary storage device 1002, a memory device 1003, a CPU 1004, an interface device 1005, a display device 1006, an input device 1007, and the like that are connected to each other via a bus B.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions pertaining to the control apparatus 100 in accordance with the program stored in the memory device 1003. The interface device 1005 is used as an interface for connecting to a network, and functions as means for input/output via the network. The display device 1006 displays a graphical user interface (GUI) or the like according to a program. The input device 157 is configured of a keyboard, a mouse, buttons, a touch panel, or the like, and is used to input various operation instructions.

### Variable Definition

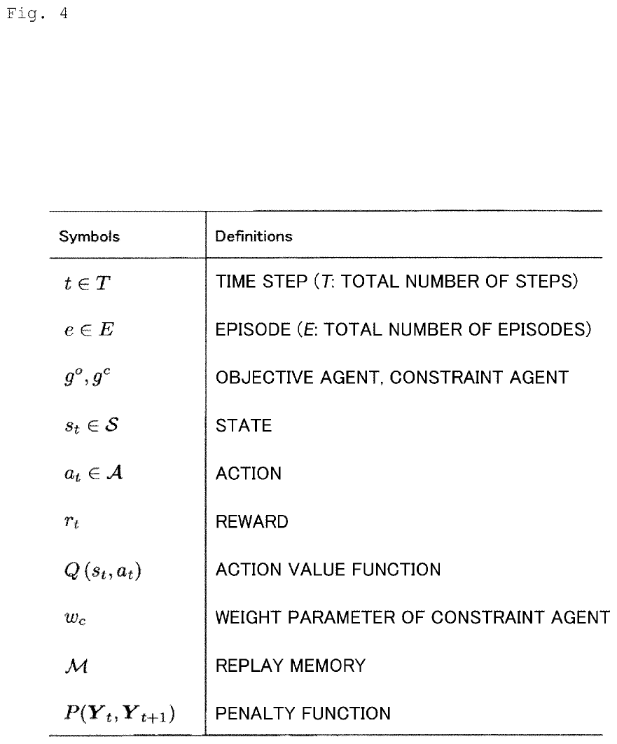

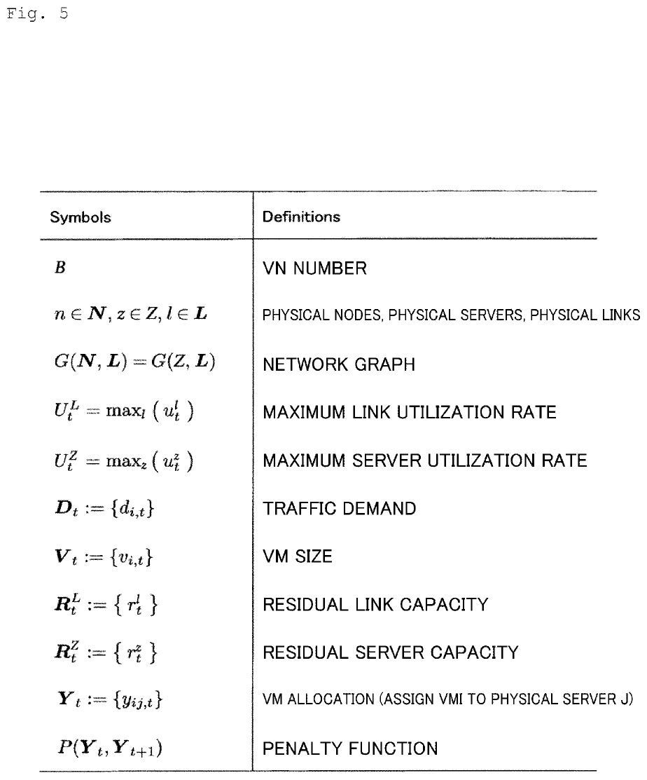

The definitions of variables used in the following description are shown in FIGS. 4 and 5. FIG. 4 is a variable definition relating to reinforcement learning in consideration of safety. As shown in FIG. 4, variables are defined as follows.

t∈T: time step (T: total number of steps)
e∈E: episode (E: total number of episodes)
go, gc: Objective agent, Constraint agent
st∈S: S is a set of states st
at∈A: A is a set of actions at
rt: Reward at time t
Q(st, at): Action value function
wc: Weight parameter of Constraint agent gc

### M: Replay Memory

P(Yt, Yt+1): Penalty function

FIG. 5 shows the definition of variables related to the dynamic VN allocation. As shown in FIG. 5, the following variables are defined in h.

B: VN number
n∈N, z∈Z, l∈L: N is a set of physical nodes n, Z is a set of physical servers z, L is a set of physical links l
G(N, L)=G(Z, L): Network graph
ULt=max l(ult): Maximum value in l∈L of a link utilization rate ult at time t (a maximum link utilization rate)
UZt=max z(urt): Maximum value in z∈Z (maximum server utilization rate) of server utilization rate uzt at time t
Dt:={di, t}: set of traffic demand
Vt:={vi, t}: set of VM size (VM demand)
RLt:={rlt}: Set of residual link capacity l∈L
RZt:={rzt}: Set of residual server capacity z∈Z
Yt:={yij, t}: Set of VM allocation (assign VMi to physical server j) at time t
P(Yt, Yt+1): Penalty function

In the above definition, the link utilization rate “ULT” is “1−residual link capacity/total capacity” in the link l. The server utilization rate urt is “1−residual server capacity/total capacity” in the server z.

### Overview

An outline of the reinforcement learning operation in the control apparatus 100 which executes reinforcement learning in consideration of safety will be described.

In the present embodiment, two kinds of agents are introduced, and are called an “Objective Agent go” and a “Constraint Agent gc”, respectively. The go learns the action of the maximum objective function. The gc learns an action to suppress violation of the constraint condition. More specifically, the gc learns the action in which the number of times of the violation (or excess) of the constraint condition is minimum. Since the gc does not receive the reward according to the increase/decrease of the objective function, the gc does not select the action of violating the restriction condition to maximize the cumulative reward.

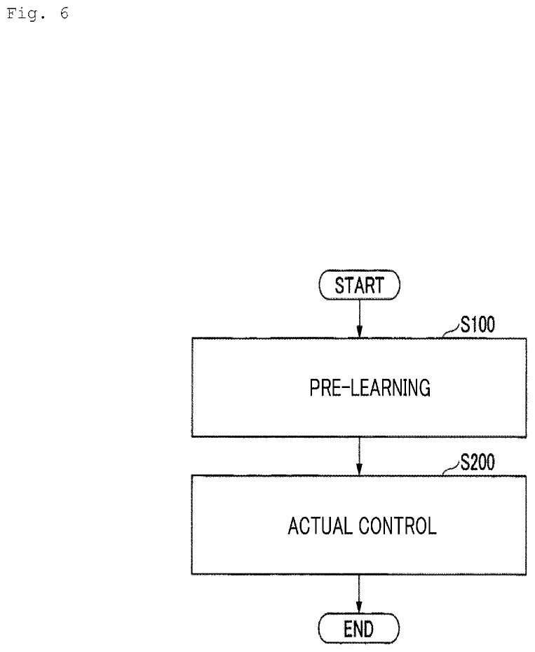

FIG. 6 is a flowchart illustrating an example of an overall operation of the control apparatus 100. As shown in FIG. 6, a pre-learning unit 110 of the control apparatus 100 performs pre-learning in S100, and performs actual control in S200.

The pre-learning unit 110 learns the action value function Q(st, at) in the pre-learning of S100, and stores the learned Q(st, at) in the data storage unit 140. The action value function Q(st, at) represents an estimated value of the cumulative reward obtained when the action at is selected in the state st. In this embodiment, the action value function Q(st, at) of go and gc are represented by Qo(st, at) and Qc(st, at), respectively. A reward function is prepared for each agent, and each Q value is learned separately by reinforcement learning.

At the time of actual control of S200, the allocation unit 130 of the control apparatus 100 reads each action value function from the data storage unit 140, determines the total Q value based on the weighted linear sum of the Q values of the two agents, and determines the total Q value, and the action that maximizes the Q value is the optimum action at time t (VN allocation (determination of the VM allocation destination server)). That is, the control apparatus 100 calculates the Q value by the following equation (1).

[Math. 1]

Q(s,a):=Qₒ(s,a)+w_{c}Q_{c}(s,a) (1)

The wc in the equation (1) represents a weight parameter of gc, and represents the importance of observing the constraint conditions. By adjusting the weight parameter, it is possible to adjust after learning how much the constraint condition should be observed.

### Dynamic VN Allocation Problem

VN allocation in the present embodiment, which is premised on pre-learning and actual control, will be described.

In the present embodiment, it is assumed that each VN demand is composed of a traffic demand as a virtual link, and a VM (virtual machine) demand (VM size) as a virtual node. As shown in FIG. 1, it is assumed that the physical network G (N, L) is composed of a physical link L and a physical node N, and each physical server Z is connected to each physical node N. That is, it is assumed that G(N, L)=G(Z, L).

The objective function is to minimize the sum of the maximum link utilization rate ULt and the maximum server utilization rate UZt over all times. That is, the objective function can be expressed by the following equation (2).

$$[ Math . 2 ]$$

$$min : {\sum }_{t ∈ T} ( {U}_{t}^{L} + {U}_{t}^{Z} ) \qquad ( 2 )$$

The large maximum link utilization rate or maximum server utilization rate means that the physical resources used are biased, and that resource utilization efficiency is not good. Equation (2) is an example of an objective function for improving (maximizing) resource utilization efficiency.

The constraint condition is that the link utilization rate in all links is less than 1 and a server utilization rate of all servers is less than 1, at all times. That is, the constraint condition is represented by ULt <1, and USt <1.

In the present embodiment, it is assumed that there are VN demands of B (B≥1) and each user requests one VN demand. The VN demand is composed of a start point (user), an end point (VM), a traffic demand Dt, and a VM size Vt. Here, VM size indicates the processing capacity of VM required by users, and it is assumed that server capacity is consumed by the VM size when VM are allocated to physical servers, and link capacity is consumed by the traffic demand.

In the actual control, in the present embodiment, it is assumed that a discrete time step is assumed and the VN demand changes in each time step. At each time step t, the VN demand is first observed. Next, the learned agent calculates the optimum VN allocation at the next time step t+1 based on the observation value. Finally, the route and the VM arrangement are changed on the basis of the calculation result. The above-mentioned “learned agent” corresponds to the allocation unit 130 that executes the allocation process using the learned action value function.

### About Learning Model

The learning model of reinforcement learning in this embodiment will be explained. In this learning model, the state st, the action at, and the reward rt are used. The state st and the action at are common to the two types of agents, and the reward rt is different between the two types of agents. The learning algorithm is common to two kinds of agents.

The state st at time t is defined as st=[Dt, Vt, RLt, RZt]. Here, Dt and Vt are the traffic demand of all VNs and the VM size (VM demand) of all VNs, respectively, and RLt and RZt are the residual bandwidth of all links and the residual capacity of all servers, respectively.

Since the VMs that make up the VN are assigned to any of the physical servers, there are as many VM allocation methods as there are physical servers. Further, in this example, when the physical server to which the VM is assigned is determined, the route from the user (the physical node in which the VM exists) to the physical server to which the VM is assigned is uniquely determined. Therefore, since there are B VNs, there are |Z|B VN allocations, and the candidate set is defined as A.

At each time t, one action at is selected from A. As described above, in this learning model, since the route is uniquely determined for the allocation destination server, VN allocation is determined by the combination of VM and the allocation destination server.

Next, the reward calculation in the learning model will be described. In the reward calculation here, the action at is selected in the state st, and a reward calculation unit 120 of the control apparatus 100 calculates a reward RT when the state st 1 is reached.

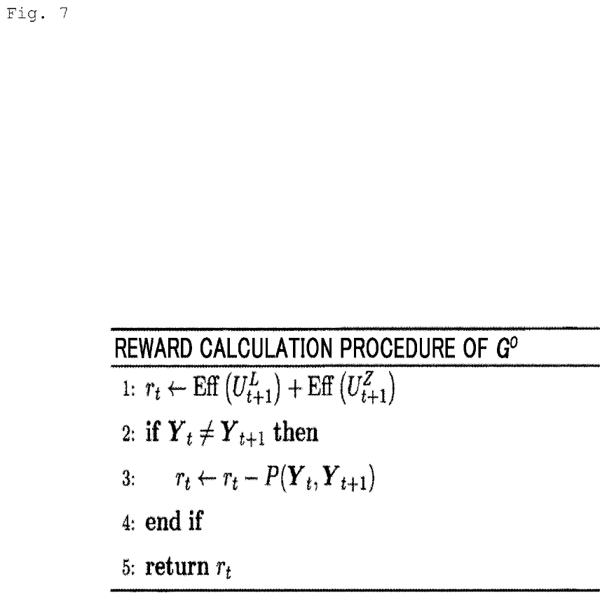

FIG. 7 shows a reward calculation procedure of go executed by the reward calculation unit 120. The reward calculation unit 120 calculates the reward rt by Eff(ULt+1)+Eff(UZt+1) in the first line. Eff(x) represents an efficiency function, and is a function defined by the following equation (3) so that Eff(x) decreases as x increases.

$$[ Math . 3 ]$$

$$Eff ( x ) = \{ \begin{matrix}0.5 & ( x \leq 0.2 ) \\ - x + 0.9 & ( 0.2 < x \leq 0.9 ) \\ - 2 x + 1.8 & ( 0.9 < x \leq 1 ) \\ - 1.5 & ( 1 < x )\end{matrix} \qquad ( 3 )$$

In the above equation (3), in order to strongly avoid a state close to a violation of the constraint condition (ULt+1 or UZt+1 becomes 90% or more), Eff(x) is decreased Eff(x) by 2 times, when x is 0.9 or more. In order to avoid unnecessary VN reallocation (VN reallocation when ULt+1 or UZt+1 is 20% or less), Eff(x) is set to be constant when x is 0.2 or less.

In the 2nd to 4th lines, the reward calculation unit 120 gives a penalty according to the reassignment of the VN in order to suppress unnecessary relocation of the VN.

YT is an allocation state(an allocation destination server of the VM for each VM) of VN. In the 2nd line, when the reward calculation unit 120 determines that the reallocation has been performed (when Yt and Yt+1 are different), the reward calculation unit 120 proceeds to the 3rd line and sets rt−P (Yt, Yt+1) as rt. P (Yt, Yt+1) is a penalty function for suppressing the rearrangement of the VN, and is set so that the P value is large when the reallocation is suppressed and the P value is small when the rearrangement is allowed.

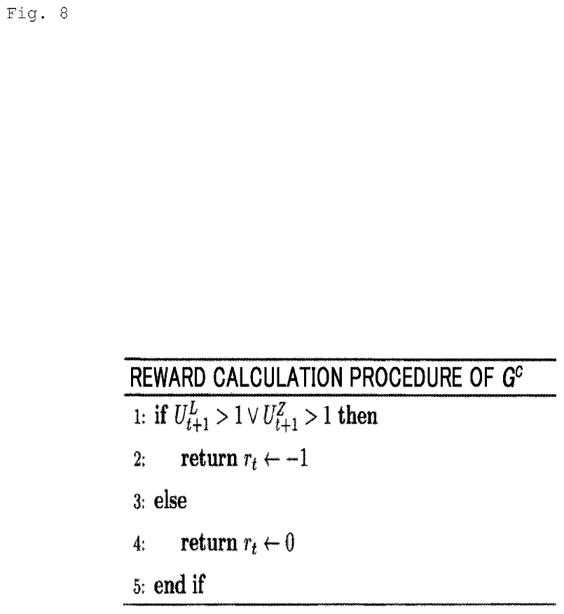

FIG. 8 shows a gC reward calculation procedure executed by the reward calculation unit 120. As shown in FIG. 8, the reward calculation unit 120 returns −1 as rt when ULt+1>1 or UZt+1>1, and returns 0 as rt in other cases. That is, the reward calculation unit 120 returns rt corresponding to the end condition of the episode when the allocation violating the constraint condition is performed.

### Pre-Learning Operation

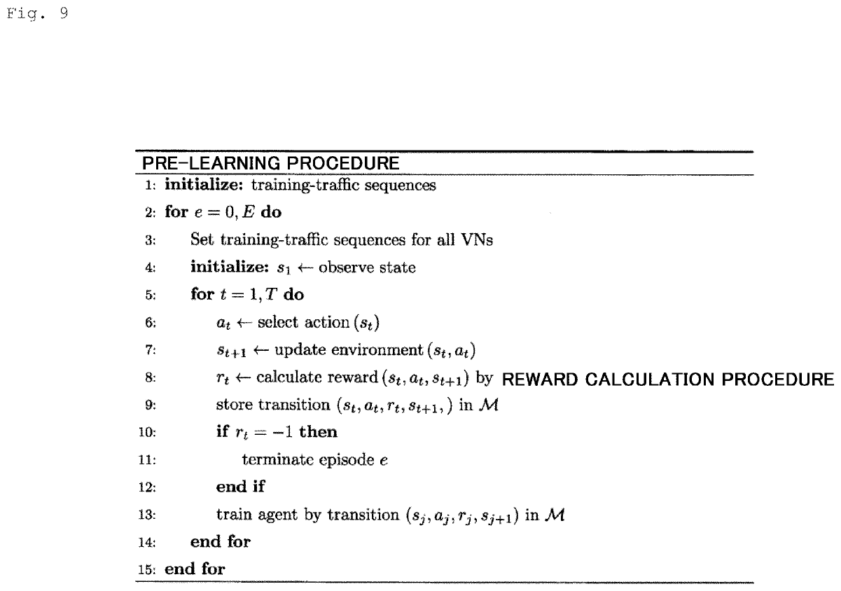

FIG. 9 shows a pre-learning procedure (pre-learning algorithm) of reinforcement learning (safe-RL) in consideration of safety, which is executed by the pre-learning unit 110. The pre-learning procedure is common to the two kinds of agents, and the pre-learning unit 110 executes pre-learning for each agent according to the procedure shown in FIG. 9.

A series of actions of T time steps is called an episode, and the episode is repeatedly executed until learning is completed. Prior to learning, the pre-learning unit 110 generates candidates for learning traffic demand and VM demand having the number of steps T, and stores them in the data storage unit 140 (first line).

At the beginning of each episode (lines 2-15), the pre-learning unit 110 randomly calculates the traffic demand Dt and VM demand Vt of T time steps for all VNs from the candidates for learning traffic demand and VM demand select.

After that, the pre-learning unit 110 repeatedly executes a series of procedures (lines 5-13) at each t of t=1 to T. The pre-learning unit 110 generates a pair of learning samples (state st, action at, reward rt, next state st+1) in the 6th to 9th lines, and stores the learning sample in Replay Memory M.

In the generation of the learning sample, the action selection according to the current state st and the Q value, the update of the state based on the action at (relocation of the VN), and the calculation of the reward rt in the updated state st+1 is performed. For the reward rt, the pre-learning unit 110 receives the value calculated by the reward calculation unit 120. The state st, action at, and reward rt are as described above. Lines 10-12 refer to the end condition of the episode. In this learning model, an end condition of the pre-learning unit 110 is rt=−1.

On the 13th line, the pre-learning unit 110 randomly takes out a learning sample from the Replay Memory and learns the agent. In the learning of the agent, the Q value is updated based on the algorithm of reinforcement learning. Specifically, Qo(st, at) is updated when learning go, and Qc(st, at) is updated when learning gc.

In the present embodiment, the learning algorithm of reinforcement learning is not limited to a specific algorithm, and any learning algorithm can be applied. As an example, the algorithm described in reference (V. Mnihet, al., “Human-level control through deep reinforcement learning,” Nature, vol 518, no 7540, p 529, 2015) can be used as a learning algorithm for reinforcement learning.

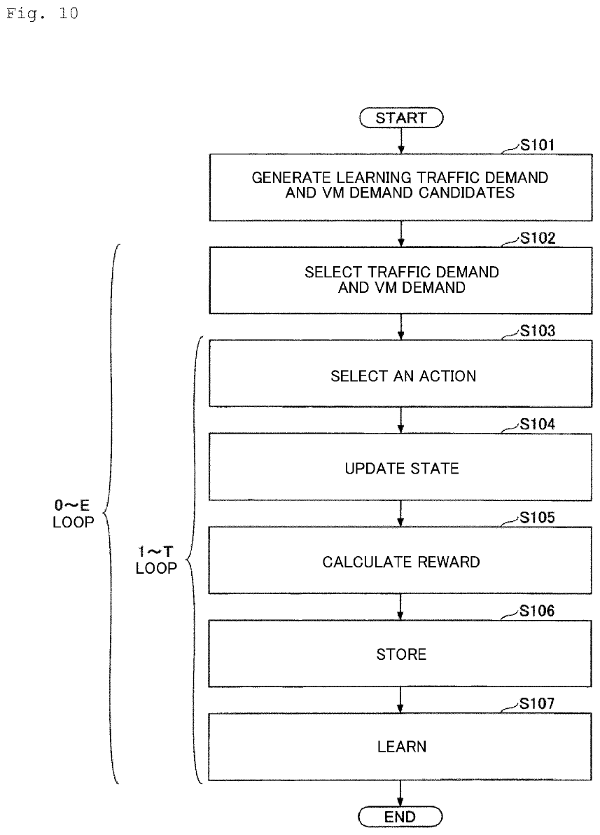

An operation example of the pre-learning unit 110 based on the above-mentioned reward calculation procedure will be described with reference to the flowchart of FIG. 10. The processing of the flowchart of FIG. 10 is performed for each of the agent go and the agent gc.

It should be noted that state observation and behavior (allocation of VN to physical resources) in pre-learning may be performed for the actual physical network 200, or for a model equivalent to the actual physical network 200. In the following, it is assumed that the operation is performed for the actual physical network 200.

In S101, the pre-learning unit 110 generates learning traffic demand and VM demand candidates having the number of steps T, and stores them in the data storage unit 140.

S102 to S107 are executed for each episode. In addition, S103 to S107 are performed in each type step in each episode.

In S102, the pre-learning unit 110 randomly selects the traffic demand Dt and the VM demand Vt of each t of each VN from the data storage unit 140. Further, the pre-learning unit 110 acquires (observes) the initial (current) state s1 from the physical network 200 as the initialization process.

In S103, the pre-learning unit 110 selects the action at so that the value (Q value) of the action value function is maximized. That is, the VN allocation destination server in each VN is selected so that the value (Q value) of the action value function is maximized. In S103, the pre-learning unit 110 may select the action at so that the value (Q value) of the action value function becomes the maximum value of the action value function with a predetermined probability.

In S104, the pre-learning unit 110 sets the selected action (VN allocation) to the physical network 200, and obtains the VM demand Vt+1, traffic demand Dt+1, and state st+1. The state st+1 includes residual link capacity RLt+1 and residual server capacity RZt+1 updated by the action at selected in S103.

In S105, the reward calculation unit 120 calculates the reward rt by the above-mentioned calculation method. In S106, the reward calculation unit 120 stores a pair of (state st, action at, reward rt, next state st+1) in the Replay Memory M (data storage unit 140).

In S107, the pre-learning unit 110 randomly selects a learning sample (state sj, action aj, reward rj, next state sj+1) from the Replay Memory M (data storage unit 140), and updates the action value function.

### Actual Control Operation

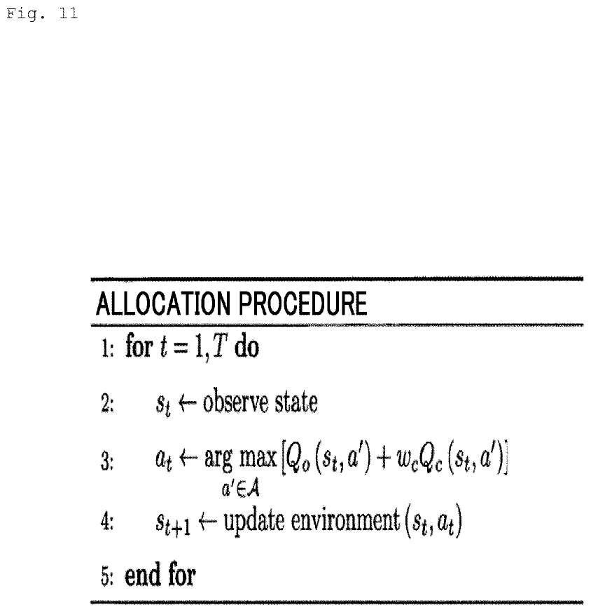

FIG. 11 shows a dynamic VN allocation procedure by reinforcement learning in consideration of safety (safe-RL), which is executed by the allocation unit 130 of the control apparatus 100. Here, it is assumed that Qo(s, a) and Qc(s, a) have already been calculated by pre-learning, and are stored in the data storage unit 140, respectively.

The allocation unit 130 repeatedly executes the 2nd to 4th lines for each t of t=1 to T. The allocation unit 130 observes the state st in the 2nd line. In the 3rd line, the action at that maximizes Qo(s, a)+wcQc(s, a) is selected. In the 4th line, the VN allocation for the physical network 200 is updated.

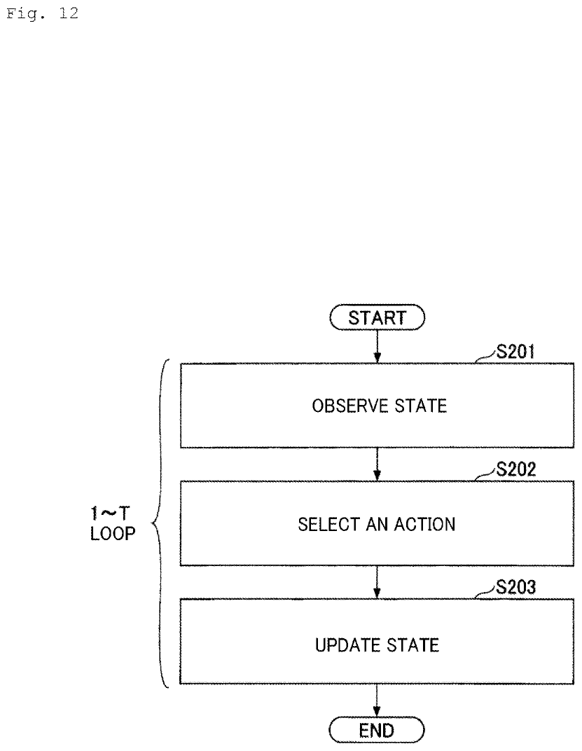

An example of the operation of the allocation unit 130 based on the actual control procedure described above will be described with reference to the flowchart of FIGS. 12. S201 to S203 are executed in each time step.

The allocation unit 130 observes (acquires) the state st (=VM demand Vt, traffic demand Dt, residual link capacity RLt, residual server capacity RZt) at time t. Specifically, for example, VM demand Vt and traffic demand Dt are received from each user (user terminal or the like), and the residual link capacity RLt and the residual server capacity RZt are obtained from the physical network 200 (or the operation system monitoring the physical network 200). The VM demand VMt and the traffic demand Dt may be values obtained by demand forecasting.

In S202, the allocation unit 130 selects the action at that maximizes Qo(s, a)+wcQc(s, a). That is, the allocation unit 130 selects the VM allocation destination server in each VN so that Qo(s, a)+wcQc(s, a) becomes maximum.

In S203, the allocation unit 130 updates the state. Specifically, the allocation unit 130 sets the VM to be allocated to each allocation destination server in the physical network 200 for each VN, and sets the route in the physical network 200 so that traffic according to the demand flows on the correct route (set of links).

### Other Examples

As other examples, the following modification examples 1 to 3 will be described.

### Modification 1

In the above example, the number of types of agents is two, but the number of types is not limited to two and can be divided into three or more. Specifically, it is divided into n pieces such as Q(s, a):=Σnk=1wkQk(s, a), and n reward functions are prepared. With the above-mentioned device, even if there are a plurality of objective functions of the VN allocation problem to be solved, an agent can be prepared for each objective function. Further, by preparing an agent for each constraint condition, it is possible to deal with a complicated allocation problem and adjust the importance for each constraint condition.

### Modification 2

In the above-mentioned example, in the pre-learning (FIGS. 9 and 10), the pre-learning of gc and go was performed individually. Here, this is just an example. Instead of performing the pre-learning of gc and go individually, the learning result of gc may be utilized for the learning of go after the learning of gc is performed first. Specifically, learning of the go utilizes Qc(s, a) that is the learning result of gc, and learns the action value function Qo(s, a) as to maximize Qo(s, a)+wcQc(s, a).

In this case, instead of selecting an action such that arga′∈A max[Qo(st, a′)+wcQc(st, a′)] in actual control, arga′∈A max[Qo(st, a′)], you may choose the action that becomes. By the above-mentioned device, it is possible to suppress the violation of the constraint condition of go during learning and to improve the efficiency of learning of go. Further, by suppressing the constraint condition violation during the pre-learning, it is possible to suppress the influence of the constraint condition violation when the pre-learning is performed in the actual environment.

### Modification 3

In this case, in the real control, Instead of selecting the action of arga′∈A max[Qo(st, a′)+wcQc(st, a′)], action selection can also be designed manually, for example, “Among actions with Qc greater than or equal to wc, the one with the largest Qo is selected”. With the above-mentioned device, the behavior selection design can be changed according to the nature of the assignment problem, such as limiting the violation of the constraint condition more or allowing some violation of the constraint condition.

### Effect of the Embodiment

As described above, in the present embodiment, two types of agents of the go that learns the action that maximizes the objective function, and the gc that learns the action that minimize the number of violations (excess number) of the constraint condition were introduced, and pre-learning was performed separately for each, and the Q values of the two types of agents were expressed by a weighted linear sum.

By such a technique, violation of restriction conditions can be suppressed for a dynamic VN allocation method by reinforcement learning. Further, by adjusting the weight (wc), the importance of the constraint condition compliance can be adjusted after learning.

### Summary of Embodiment

This specification discloses at least the control apparatus, the virtual network allocation method, and the program of each of the following items.

### Section 1

A control apparatus for allocating a virtual network to a physical network having a link and a server by reinforcement learning, a control apparatus comprising: a pre-learning unit configured to learn a first action value function corresponding to an action of performing a virtual network allocation so as to improve utilization efficiency of physical resources in the physical network, and a second action value function corresponding to an action of performing the virtual network allocation so as to suppress violation of constraint conditions in the physical network; and

an allocation unit that allocates the virtual network to the physical network by using the first action value function and the second action value
function.

### Section 2

The control apparatus according to section 1, wherein the pre-learning unit learns the action value function corresponding to the action for performing the virtual network allocation so that a sum of a maximum link utilization rate, and a maximum server utilization rate in the physical network becomes minimum as the first action value function,

the pre-learning unit learns the action value function corresponding to the action for performing virtual network allocation so that the number of times of violation of a restriction condition is minimized as the second action value
function.

### Section 3

The control apparatus according to section 1 or 2, wherein the constraint condition is that the link utilization rate of all links in the physical network is less than 1, and server utilization rate of all servers in the physical network is less than 1.

### Section 4

The control apparatus according to any one of sections 1 to 3, wherein the allocation unit selects the action for allocating the virtual network to the physical network so that a value of a weighted sum of the first action value function and the second action value function becomes maximum.

### Section 5

A virtual network allocation method executed by a control apparatus for allocating a virtual network to a physical network having a link and a server by reinforcement learning, a virtual network allocation method comprising: a pre-learning step of learning a first action value function corresponding to an action of performing a virtual network allocation so as to improve utilization efficiency of physical resources in the physical network, and a second action value function corresponding to an action of performing the virtual network allocation so as to suppress violation of constraint conditions in the physical network; and

an allocation step of allocating a virtual network to the physical network by using the first action value function and the second action value
function.

### Section 6

A program for causing a computer to function as the units of the control apparatus according to any one of sections 1 to 4.

Although the embodiment has been described above, the present invention is not limited to such a specific embodiment, and various modifications and changes can be made within the scope of the gist of the present invention described in the claims.

### Reference Signs List

100 Control apparatus
110 Pre-learning unit
120 Reward calculation unit
130 Allocation unit
140 Data storage unit
200 Physical network
300 Physical node
400 Physical link
1000 Drive device
1001 Recording medium
1002 Auxiliary storage device
1003 Memory device
1004 CPU
1005 Interface device
1006 Display device
1007 Input device

1. A control apparatus for allocating a virtual network to a physical network having a link and a server by reinforcement learning, the control apparatus comprising:
a processor; and
a memory storing program instructions that cause the processor to:
learn a first action value function corresponding to an action of performing a virtual network allocation so as to improve utilization efficiency of physical resources in the physical network, and a second action value function corresponding to an action of performing the virtual network allocation so as to suppress violation of constraint conditions in the physical network; and
allocate the virtual network to the physical network by using the first action value function and the second action value function.

2. The control apparatus according to claim 1, wherein
the program instructions further cause the processor to learn the action value function corresponding to the action for performing the virtual network allocation so that a sum of a maximum link utilization rate, and a maximum server utilization rate in the physical network becomes minimum as the first action value function, and
learn the action value function corresponding to the action for performing virtual network allocation so that the number of times of violation of the constraint conditions is minimized as the second action value function.

3. The control apparatus according to claim 1, wherein the constraint conditions are that a link utilization rate of all links in the physical network is less than 1, and a server utilization rate of all servers in the physical network is less than 1.

4. The control apparatus according to claim 1, wherein the program instructions further cause the processor to select the action for allocating the virtual network to the physical network so that a value of a weighted sum of the first action value function and the second action value function becomes maximum.

5. A virtual network allocation method executed by a control apparatus for allocating a virtual network to a physical network having a link and a server by reinforcement learning, the virtual network allocation method comprising:
learning a first action value function corresponding to an action of performing a virtual network allocation so as to improve utilization efficiency of physical resources in the physical network, and a second action value function corresponding to an action of performing the virtual network allocation so as to suppress violation of constraint conditions in the physical network; and
allocating a virtual network to the physical network by using the first action value function and the second action value function.

6. A non-transitory computer-readable recording medium having stored therein a program for causing a computer to perform the virtual network allocation method according to claim 5.
